(19) United States
(12) Patent Application Publication
(10) Pub. No.: US 2012/0168517 A1
(43) Pub. Date: Jul. 5, 2012

(54) SIM CARD ASSEMBLY, METHOD OF MANUFACTURING THE SAME, AND ELECTRONIC DEVICE INCLUDING THE SAME

(75) Inventor: Hong Suk LEE, Seongnam (KR)

(73) Assignee: SAMSUNG ELECTRO-MECHANICS CO., LTD., Suwon (KR)

(21) Appl. No.: 13/315,646

(22) Filed: Dec. 9, 2011

(30) Foreign Application Priority Data
Dec. 29, 2010 (KR) 10-2010-0138333

(51) Int. Cl. G06K 19/077; H01P 11/00

(52) U.S. Cl. 235/492; 29/600

(57) ABSTRACT

There are provided a subscriber identification module (SIM) card assembly, a method of manufacturing the same, and an electronic device including the same. The SIM card assembly includes: a SIM card on which personal identification information is stored; and a SIM card holder to which the SIM card is detachably mounted and including a covering part protecting the SIM card, the covering part being formed integrally with an antenna for local radio communications.

### CROSS-REFERENCE TO RELATED APPLICATIONS

This application claims the priority of Korean Patent Application No. 10-2010-0138333 filed on Dec. 29, 2010 in the Korean Intellectual Property Office, the disclosure of which is incorporated herein by reference.

### BACKGROUND OF THE INVENTION

1. Field of the Invention

The present invention relates to a SIM card assembly, a method of manufacturing the same, and an electronic device including the same, and more particularly, to a SIM card assembly having an antenna for local radio communications, a method of manufacturing the same, and an electronic device including the same.

2. Description of the Related Art

A mobile communications terminal supporting radio communications, such as a cellular phone, a PDA, a navigation device, a notebook computer, or the like, is an indispensable device in modern society. With the development of technologies, various functions such as radio-frequency identification (RFID), near field communications (NFC), global system for mobile communications (GSM), universal mobile telecommunications system (UMTS), general packet radio service (GPRS), wideband code division multiple access (WCDMA), wireless lan (WIFI), and the like have been added to the mobile communications terminal. One of the most important components supporting the functions is an antenna.

In order to implement these functions in the mobile communications terminal, a matching circuit for implementing these functions should be provided in a main body of the mobile communications terminal and an antenna should be designed so as to be operated in a frequency band according to each function.

However, a position of the matching circuit and a connection structure of the antenna are designed to be different for each mobile communication terminal, leading to a problem in that universality is degraded in designing the antenna for adding these functions.

In addition, the mobile communications terminal should have space previously secured therein for the antenna for adding these functions thereto, having a problem in that spatial utilization thereof is degraded.

### SUMMARY OF THE INVENTION

An aspect of the present invention provides a subscriber identification module (SIM) card assembly that forms an antenna for implementing various communications functions in a SIM card holder to thereby implement the functions in all devices, in common, without changing an existing structure of an electronic device such as a mobile communications terminal, a method of manufacturing the same, and an electronic device including the same.

According to an aspect of the present invention, there is provided a subscriber identification module (SIM) card assembly including: a SIM card on which personal identification information is stored; and a SIM card holder to which the SIM card is detachably mounted and including a covering part protecting the SIM card, the covering part being formed integrally with an antenna for local radio communications.

The SIM card assembly may further include an antenna frame allowing the antenna to be embedded in the covering part by an insert injection method.

The covering part may be formed of a plastic injection-molded material.

The antenna may include a radiator transmitting and receiving signals and a connection member electrically connecting the radiator to the SIM card.

The radiator and one end of the connection member may be embedded in the covering part, and the other end of the connection member may be inwardly protruded from the covering part.

The connection member may be in elastic contact with the SIM card, be formed of a member separate from the radiator, and be formed of a C-clip or a Pogo-pin.

The antenna may be a low frequency antenna allowing the SIM card to perform radio-frequency identification (RFID), near field communications (NFC), or communications using a wireless lan (WIFI).

According to another aspect of the present invention, there is provided a method of manufacturing a subscriber identification module (SIM) card assembly, the method including: preparing an antenna for local radio communications; disposing the antenna in a mold for manufacturing a covering part, the covering part protecting the SIM card; manufacturing the covering part formed integrally with the antenna by filling the mold for manufacturing the covering part with a resin material; forming a SIM card holder by coupling the covering part to a seating part on which the SIM card is seated; and inserting the SIM card into the SIM card holder.

The manufacturing of the covering part may be performed such that a radiator transmitting and receiving signals and one end of a connection member electrically connecting the radiator to the SIM card are embedded in the covering part.

The manufacturing of the covering part may be performed such that the other end of the connection member is inwardly protruded from the covering part.

The preparing of the antenna may be performed such that the antenna is disposed in a mold for manufacturing an antenna frame and the mold for manufacturing the antenna frame is filled with a resin material so that the antenna is formed integrally with the antenna frame.

The preparing of the antenna may be performed such that the radiator transmitting and receiving signals and one end of the connection member electrically connecting the radiator to the SIM card are embedded in the antenna frame.

According to another aspect of the present invention, there is provided an electronic device including the SIM card assembly as described above.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view schematically showing a mobile communications terminal, an electronic device according to an exemplary embodiment of the present invention;

FIG. 2 is a partial perspective view showing a state in which a SIM card is coupled to a mobile communications terminal, an electronic device according to an exemplary embodiment of the present invention;

FIG. 3 is a perspective view showing an antenna of a mobile communications terminal, an electronic device according to an exemplary embodiment of the present invention;

FIG. 4 is a view showing the configuration of a SIM card of a mobile communications terminal, an electronic device according to an exemplary embodiment of the present invention;

FIG. 5 is a perspective view of a SIM card coupling portion of FIG. 2;

FIG. 6 is a cross-sectional view of a SIM card coupling portion of FIG. 2;

FIG. 7 is a perspective view of an antenna frame of a mobile communications terminal, an electronic device according to an exemplary embodiment of the present invention;

FIG. 8 is a cross-sectional view of an antenna frame of a mobile communications terminal, an electronic device according to an exemplary embodiment of the present invention;

FIG. 9 is a cross-sectional view of an antenna frame of a mobile communications terminal, an electronic device according to another exemplary embodiment of the present invention;

FIG. 10 is a cross-sectional view of an antenna frame of a mobile communications terminal, an electronic device according to another exemplary embodiment of the present invention;

FIGS. 11A through 11C are views showing a method of manufacturing the antenna frame of FIG. 8;

FIG. 12A is a cross-sectional view of a covering part of a SIM card holder having an antenna embedded therein according to an exemplary embodiment of the present invention; and

FIG. 12B is a cross-sectional view schematically showing the way in which a mold for the manufacturing of the covering part of FIG. 12A is filled with a resin material in order to manufacture the covering part.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art.

Further, throughout the drawings, the same reference numerals will be used to designate the same or like components.

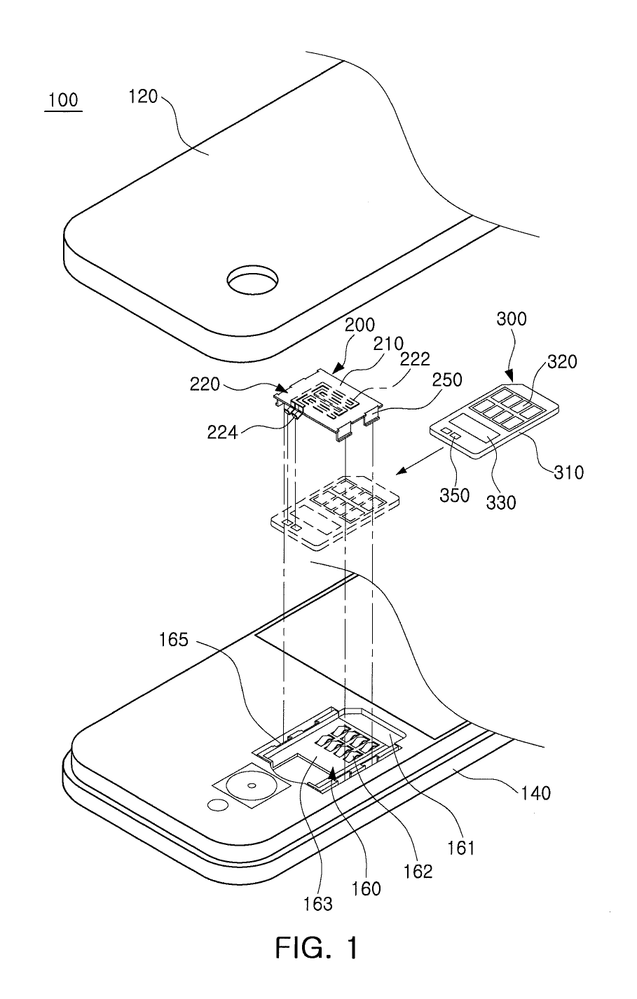

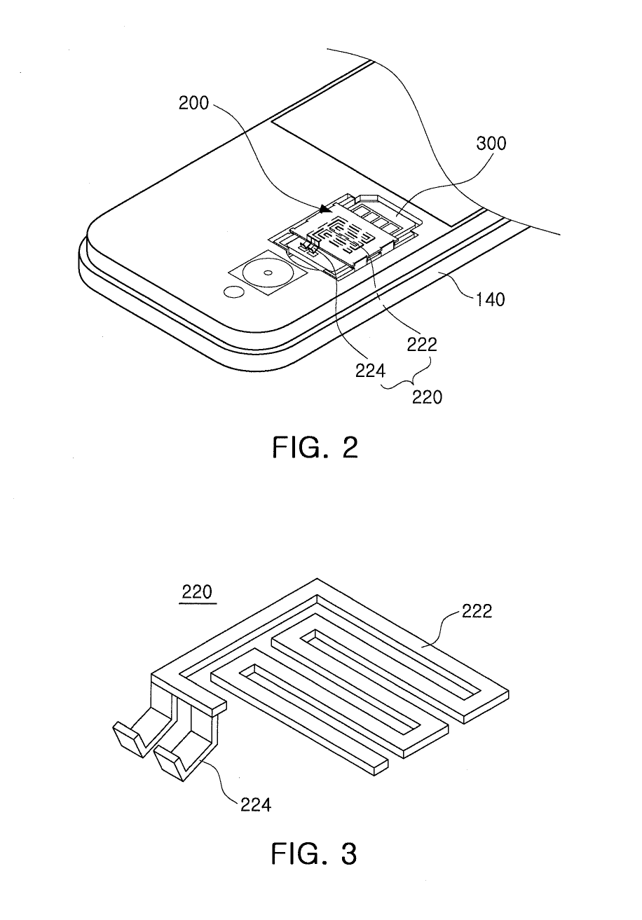

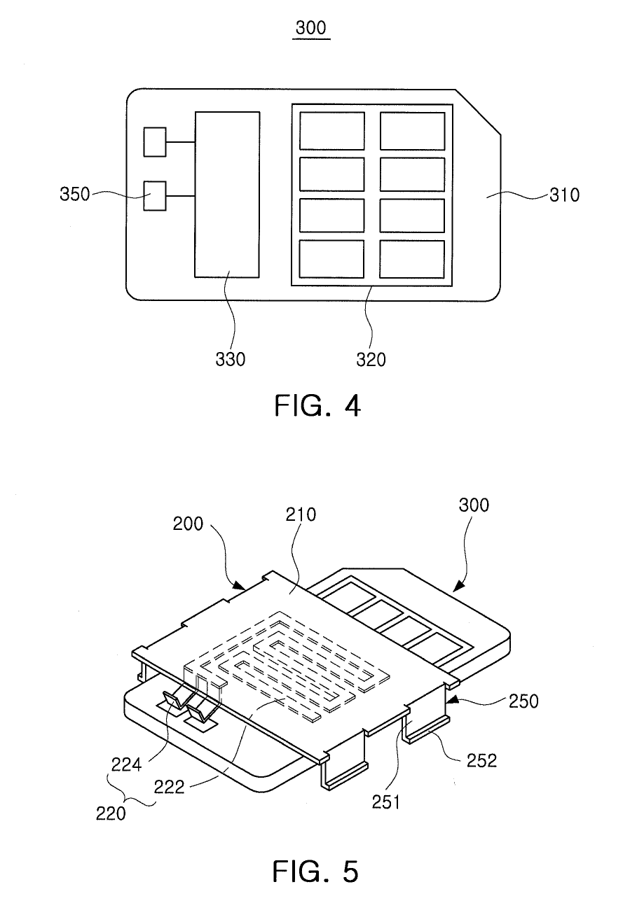

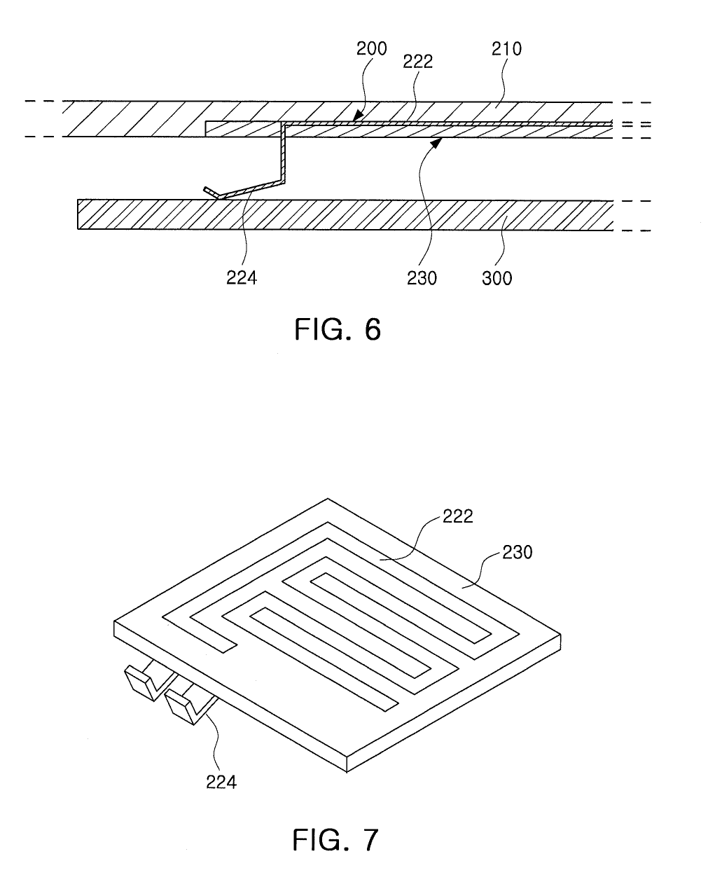

FIG. 1 is an exploded perspective view schematically showing a mobile communications terminal, an electronic device according to an exemplary embodiment of the present invention; FIG. 2 is a partial perspective view showing a state in which a subscriber identification module (SIM) card is coupled to a mobile communications terminal; FIG. 3 is a perspective view of an antenna; FIG. 4 is a view showing the configuration of a SIM card; FIG. 5 is a perspective view of a SIM card coupling portion; and FIG. 6 is a cross-sectional view of a SIM card coupling portion.

Referring to FIGS. 1 and 2, a mobile communications terminal 100, which is an electronic device according to an exemplary embodiment of the present invention, may include a case 120 and a main body 140. The main body 140 has a SIM card holder installed therein, and a SIM card 300 is detachably coupled to the SIM card holder.

In this case, the SIM card 300 refers to a subscriber identification module (SIM) card or a universal subscriber identification module (USIM) card.

The SIM card holder may include a seating part 160 on which the SIM card 300 is seated and a covering part 200 protecting the SIM card 300.

The seating part 160 may include a guide groove 161 guiding the insertion of the SIM card 300, connection terminals 162 connecting the SIM card 300 to a main circuit board (not shown) of the main body 140, and a supporting groove 163 supporting the SIM card 300.

The covering part 200 may be formed of a plastic injection-molded material. Coupling projections 250 formed on sides of the covering part 200 are insertedly coupled to coupling grooves 165 formed in sides of the supporting groove 163 such that the covering part 200 may be coupled to the seating part 160.

An antenna 220 is embedded in a panel 210 forming an upper portion of the covering part 200, such that the antenna 220 may be integrally formed with the covering part 200.

Referring to FIG. 3, the antenna 220 includes a radiator 222 transmitting and receiving signals and connection members 224 electrically connecting the radiator 222 to the SIM card 300.

The radiator 222 may be made of a conductive material such as aluminum, copper, or the like, and be formed as a pattern forming a meander line in order to receive external signals in various bands.

The connection members 224 may be formed by bending, forming, and drawing a portion of the radiator 222, wherein one end thereof may be connected to the radiator 222 to be embedded inside the covering part 200 and the other end thereof may protrude from a bottom surface the covering part 200, that is, inwardly of the covering part 200.

The antenna 220 for local radio communications may be a low frequency antenna allowing the SIM card 300 to perform radio-frequency identification (RFID), near field communications (NFC) or communications using a wireless lan (WIFI).

Meanwhile, the antenna 220 may also be a high frequency antenna allowing the SIM card 300 to serve as global system for mobile communications (GSM) or universal mobile telecommunications system (UMTS).

The antenna 220 may be formed in an antenna frame 210 to be embedded in the covering part 200 by insert injection molding. In other words, the antenna frame 210 may be formed by injection-molding the radiator 222 and the connection members 224 in a mold for manufacturing the antenna frame, and the covering part 200 may be formed by injection-molding the antenna frame 210 in a mold for manufacturing the covering part.

Referring to FIG. 4, the SIM card 300 may include amain body 310, an integrated circuit (IC) chip 320, a matching circuit 330, and connection pads 350. The SIM card 300 may be made of a plastic material.

The IC chip 320 is mounted on a substrate made of a plastic material, wherein the IC chip 320 is provided with a microprocessor, an operation system, a security module, a memory, and the like. Terminal contact pads for electrical connection of the IC chip 320 may be formed on a top surface of the substrate.

The matching circuit 330 is formed by combining an inductor and a condenser, which are connected to each other in series/parallel while having a π or T-shaped structure, matches a receiving signal received from the antenna 220 to a receiving signal appropriate for the main body 140 or the SIM card 300 of the mobile communications terminal 100, and matches a transmission signal from the main body 140 or the SIM card 300 of the mobile communication terminal 100 to a transmission signal appropriate for the antenna 220.

The connection pads 350 may be in elastic contact with the connection members 224 connected to one end of the radiator 222 so that the radiator 222 is electrically connected to the matching circuit 330.

Referring to FIGS. 5 and 6, when the SIM card 300 is inserted into the SIM card holder, the terminal contact pads of the IC chip 320 contact the connection terminals 162 and the connection members 224 of the antenna 220 are in elastic contact with the connection pads 350 of the SIM card 300. In this manner, a predetermined interval may be provided between the top surface of the SIM card 300 and the covering part 210.

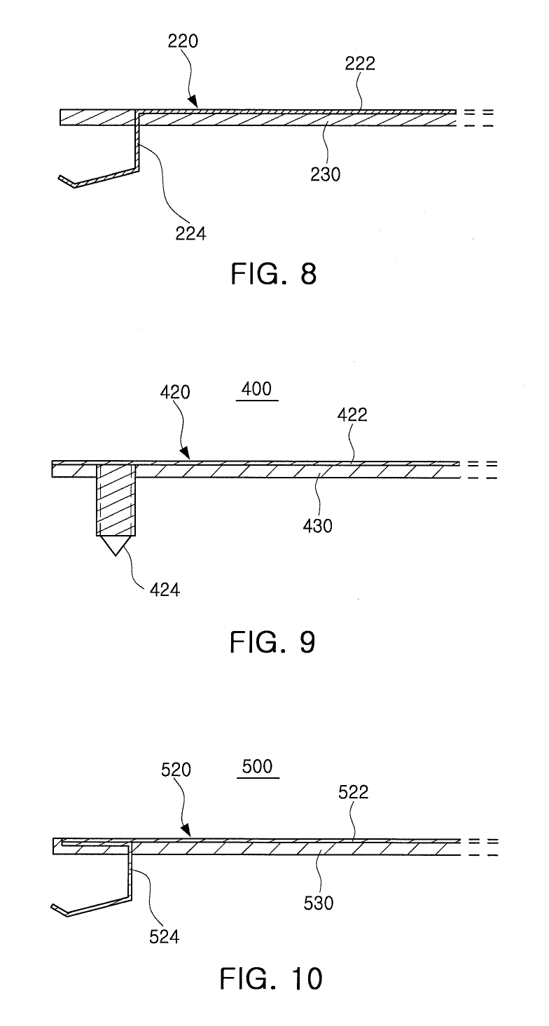

FIG. 7 is a perspective view of an antenna frame of a mobile communications terminal, an electronic device according to an exemplary embodiment of the present invention; FIG. 8 is a cross-sectional view of the antenna frame; FIG. 9 is a cross-sectional view of an antenna frame according to another exemplary embodiment; and FIG. 10 is a cross-sectional view of an antenna frame according to another exemplary embodiment.

Referring to FIGS. 7 and 8, an antenna frame 230 of a mobile communications terminal, an electronic device according to an exemplary embodiment of the present invention may include the radiator 222 formed on a surface thereof and the connection members 224 formed by penetrating the antenna frame 230 in a thickness direction thereof.

The antenna frame 230 may be formed by injection-molding the radiator 222 and the connection members 224 in a mold for manufacturing the antenna frame 230.

The exemplary embodiment of the present invention describes a case in which the antenna frame 230 is formed by performing insert injection molding on the radiator 222 and the connection members 224; however, the present invention is not limited thereto. The radiator 222 may be formed by applying and solidifying a conductive material to one surface of the antenna frame 230 and the connection members 224 may be attached to one end of the radiator 222.

Here, the radiator 222 may be formed by performing at least one of a sputtering method, a printing method, a plating method, a stamping method, a drawing method, and a dispensing method on the antenna frame 230.

In an antenna frame 430 shown in FIG. 9, a connection member 424 is attached to a surface opposite to an exposed surface of a radiator 422, wherein the connection member 424 may be configured of a pin elastically contacting the connection pad 350 of the SIM card 300 at an end opposite to an end attached to the radiator 422 and a housing accommodating the pin.

The connection member 424 may have the pin made of a spring member and having a pointed portion contacting the connection pad 350 and may be connected to the connection pad 350, while being contracted in the housing due to a force exerting pressure on the SIM card 300 when the SIM card 300 is inserted.

As an example of the connection member 424 according to the present embodiment, there is a Pogo-pin or the like.

In an antenna frame 530 shown in FIG. 10, a connection member 524 is attached to one end of a radiator 522 to have a ‘ [symbol] ’-letter shape. In other words, a first portion of the connection member 524 may be attached to a surface opposite to an exposed surface of the radiator 522, a second portion thereof may be downwardly bent and extended from the first portion, and a third portion thereof may be laterally bent and extended from the second portion.

The connection member 524 according to the present shape is attached to the radiator 522 by a surface contact, such that bonding between radiator 522 and the connection member 524 may be secured.

As an example of the connection member 524 according to the present embodiment, there is a C-clip or the like.

Hereinafter, a method of manufacturing a mobile communications terminal, an electronic device according to an exemplary embodiment of the present invention will be described.

First, schematically explaining a manufacturing method according to an exemplary embodiment of the present invention, a radiator having a predetermined pattern is manufactured, connection members are connected to the radiator, and an insert injection molding is performed to thereby manufacture an antenna frame. The antenna frame is subject to the insert injection molding to form a covering part of a SIM card holder, the covering part is coupled to a seating part of the SIM card holder, and the SIM card is inserted into the SIM card holder.

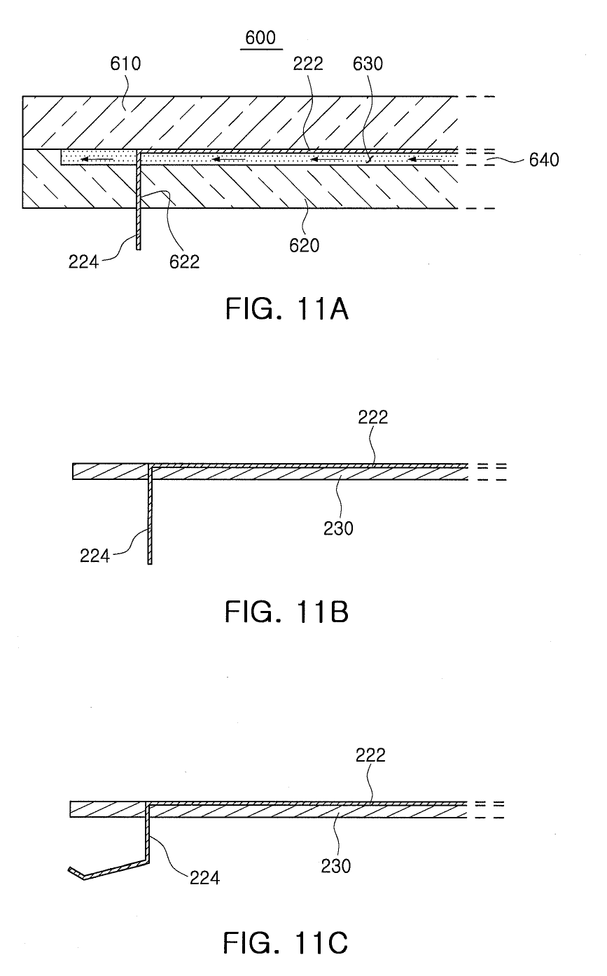

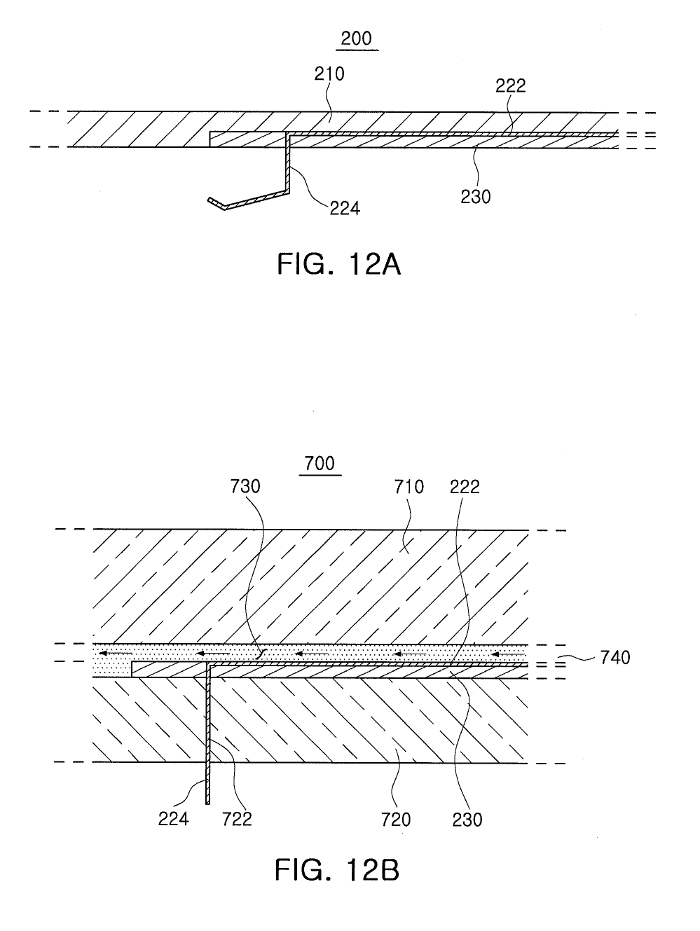

FIGS. 11A through 11C are views showing a method of manufacturing the antenna frame of FIG. 8; FIG. 12A is a cross-sectional view of a covering part of a SIM card holder having an antenna embedded therein according to an exemplary embodiment of the present invention; and FIG. 12B is a cross-sectional view schematically showing the way in which a mold for the manufacturing of the covering part of FIG. 12A is filled with a resin material in order to manufacture the covering part.

Referring to FIGS. 11A through 11C, the radiator 222 having a predetermined pattern so as to transmit and receive signals is connected with one end of the connection member 224, and is disposed in a mold 600 for manufacturing an antenna frame.

The mold 600 for the manufacturing of the antenna frame includes an upper mold 610 contacting a surface on which the radiator 222 is formed and a lower mold 620 in which a resin material is filled.

The lower mold 620 includes an internal space 630 in which the resin material is filled, wherein a bottom surface of the internal space 630 may have a filling prevention hole 622, into which a portion of the connection member 224 is inserted, in order that a portion for forming the connection member 224 is not filled with the resin material.

The filling prevention hole 622 may be formed by penetrating the lower mold 620 from the bottom surface of the internal space 630 in a thickness direction of the lower mold 620. The exemplary embodiment of the present invention describes a case in which the filling prevention hole 622 is formed by penetrating the lower mold 620 and a portion of the connection member 224 is disposed to be protruded from the bottom of the lower mold 620 by passing through the filling prevention hole 622; however, the present invention is not limited thereto. A portion of the connection member 224 may not be protruded from the bottom of the lower mold 620 or the filling prevention hole 622 may not penetrate the lower mold 620. In this case, the lower mold 620 should have a larger thickness than a length of the connection member 224.

The upper mold 610 and the lower mold 620 are combined such that the radiator 222 and the connection member 224 are to be disposed therein, the internal space 630 formed by combining the upper mold 610 and the lower mold 620 is filled with the resin material through an injection hole 640, as shown in FIG. 11A.

When the antenna frame 230 is formed by being filled with the resin material, the antenna frame 230 is separated from the mold 600 for the antenna frame, as shown in FIG. 11B.

As shown in FIG. 11C, a free end of the connection member 224 is laterally bent to form a portion elastically contacting the connection pad 350 of the SIM card 300, thereby completing the formation of the antenna frame 230 of FIG. 8.

Herein, the resin material may be made of a magnetic material having high permeability or a polymer-ceramic composite including dielectric components having high-K so that the radiation efficiency of the radiator 222 may be improved.

The exemplary embodiment of the present invention describes a case in which the connection member 224 is injection-molded, while not being bent, to form the antenna frame 230 and connection member 224 is then bent; however, the present invention is not limited thereto. The connection member 224 may also be bent and be then disposed in the mold 600 for manufacturing the antenna frame, sequentially being injection-molded.

Next, a process of manufacturing the covering part 200 of the SIM card holder by performing insert injection molding on the antenna frame 230 will be described with reference to FIG. 12B.

The covering part 200 having the antenna 220 embedded therein may be manufactured by disposing the antenna frame 230 in a mold 700 for manufacturing the covering part 200 and the mold 700 is filled with a resin material, as shown in FIG. 12B.

The mold 700 includes an upper mold 710 providing an internal space 730 filled with the resin material to form the panel 210 and the coupling projections 250 of the covering part 200 and a lower mold 720 providing an internal space in which the antenna frame 230 is disposed.

A bottom surface of the lower mold 720 may have a filling prevention hole 722, into which a portion of the connection member 224 is inserted, in order that a portion for forming the connection member 224 is not filled with the resin material.

After the antenna frame 230 is disposed in the lower mold 720 and the lower mold 720 is then combined with the upper mold 710, the resin material is injected into an internal space 730 formed by the combination of the lower and upper molds through an injection hole 740, such that one surface of the antenna frame 230 is filled with the resin material to be covered therewith. The portion filled with the resin material as described above forms the panel 210. Although the internal space for forming the coupling projection 250 is not shown in the drawings, it is obvious that the internal space having a shape corresponding to the shape of the coupling projection 250 may be formed by the combination of the upper mold 710 and the lower mold 720.

After the filling of the resin material is completed, the covering part 200 having the antenna frame 230 embedded therein is separated from the mold 700 and the connection member 224 is bent, thereby completing the formation of the covering part 200 of FIG. 12A.

Next, the covering part 200 is coupled to the seating part 160 to form the SIM card holder, and the SIM card 300 is inserted into the SIM card holder to cause an elastic contact between the connection member 224 and the connection pad 350, such that the antenna 220 is connected to the SIM card 300.

Meanwhile, the exemplary embodiment of the present invention describes a case in which the connection member is formed by bending, forming, and drawing a portion of the radiator; however, the present invention is not limited thereto. The radiator and the connection member may be separately manufactured, and then they may be attached to each other.

In addition, the exemplary embodiment of the present invention describes a case in which the antenna frame is manufactured by performing insert injection molding on the radiator and the connection member; however, the present invention is not limited thereto. The antenna frame may also be manufactured by directly applying a conductive material to the antenna frame by a sputtering method, a printing method, a plating method, a stamping method, a drawing method, a dispensing method or the like.

In addition, the exemplary embodiment of the present invention describes a case in which the covering part is manufactured by performing insert injection molding on the antenna frame; however, the present invention is not limited thereto. The covering part may also be formed by attaching the antenna frame to one surface of the panel and may be formed in various manners according to required conditions and specifications.

As set forth above, in a SIM card assembly, a method of manufacturing the same, and an electronic device including the same according to exemplary embodiments of the invention, various communication functions may be implemented without changing an existing structure of an electronic device.

In addition, there is no need to share a space for an antenna and a connection member to be connected with the antenna in an electronic device, whereby the spatial utilization of the electronic device is enhanced.

While the present invention has been shown and described in connection with the exemplary embodiments, it will be apparent to those skilled in the art that modifications and variations can be made without departing from the spirit and scope of the invention as defined by the appended claims.

What is claimed is:

1. A subscriber identification module (SIM) card assembly comprising:
a SIM card on which personal identification information is stored; and
a SIM card holder to which the SIM card is detachably mounted and including a covering part protecting the SIM card, the covering part being formed integrally with an antenna for local radio communications.

2. The SIM card assembly of claim 1, further comprising an antenna frame allowing the antenna to be embedded in the covering part by an insert injection method.

3. The SIM card assembly of claim 1, wherein the covering part is formed of a plastic injection-molded material.

4. The SIM card assembly of claim 1, wherein the antenna includes a radiator transmitting and receiving signals and a connection member electrically connecting the radiator to the SIM card.

5. The SIM card assembly of claim 4, wherein the radiator and one end of the connection member are embedded in the covering part.

6. The SIM card assembly of claim 5, wherein the other end of the connection member is inwardly protruded from the covering part.

7. The SIM card assembly of claim 4, wherein the connection member is in elastic contact with the SIM card.

8. The SIM card assembly of claim 4, wherein the connection member is formed of a member separate from the radiator.

9. The SIM card assembly of claim 4, wherein the connection member is formed of a C-clip or a Pogo-pin.

10. The SIM card assembly of claim 1, wherein the antenna is a low frequency antenna allowing the SIM card to perform radio-frequency identification (RFID), near field communications (NFC), or communications using a wireless lan (WIFI).

11. A method of manufacturing a subscriber identification module (SIM) card assembly, the method comprising:
preparing an antenna for local radio communications;
disposing the antenna in a mold for manufacturing a covering part, the covering part protecting the SIM card;
manufacturing the covering part formed integrally with the antenna by filling the mold for manufacturing the covering part with a resin material;
forming a SIM card holder by coupling the covering part to a seating part on which the SIM card is seated; and
inserting the SIM card into the SIM card holder.

12. The method of claim 11, wherein the manufacturing of the covering part is performed such that a radiator transmitting and receiving signals and one end of a connection member electrically connecting the radiator to the SIM card are embedded in the covering part.

13. The method of claim 12, wherein the manufacturing of the covering part is performed such that the other end of the connection member is inwardly protruded from the covering part.

14. The method of claim 11, wherein the preparing of the antenna is performed such that the antenna is disposed in a mold for manufacturing an antenna frame, and the mold for manufacturing the antenna frame is filled with a resin material so that the antenna is formed integrally with the antenna frame.

15. The method of claim 14, wherein the preparing of the antenna is performed such that the radiator transmitting and receiving signals and one end of the connection member electrically connecting the radiator to the SIM card are embedded in the antenna frame.

16. An electronic device including the SIM card assembly of claim 1.
